(19) United States
(12) Patent Application Publication
(10) Pub. No.: US 2012/0082906 A1
(43) Pub. Date: Apr. 5, 2012

(54) PROCESS FOR PRODUCING TRANSPORT- AND STORAGE-STABLE OXYGEN-CONSUMING ELECTRODES

(75) Inventors: Andreas Bulan, Langenfeld (DE); Rainer Weber, Odenthal (DE); Matthias Weis, Leverkusen (DE)

(73) Assignee: Bayer MaterialScience AG, Leverkusen (DE)

(21) Appl. No.: 13/251,328

(22) Filed: Oct. 3, 2011

(30) Foreign Application Priority Data
Oct. 5, 2010 (DE) 10 2010 042 004.2

(51) Int. Cl. C25F 5/00; C25B 9/06; C25B 11/03; C25B 11/00; H01M 12/06; C25B 11/06

(52) U.S. Cl. 429/405; 205/640; 205/674; 205/685; 204/284; 204/242

(57) ABSTRACT

The present invention relates to A process for producing a transport- and storage-stable sheet-like oxygen-consuming electrode comprising providing an electrically conductive support, a gas diffusion layer, and a layer comprising a silver-based catalyst; coating the support with a silver oxide-containing intermediate; and at least partly electrochemically reducing the silver oxide-containing intermediate in an aqueous electrolyte at a pH of less than 8.

### CROSS-REFERENCE TO RELATED APPLICATIONS

This application claims benefit to German Patent Application No. 10 2010 042 004.2, filed Oct. 5, 2011, which is incorporated herein by reference in its entirety for all useful purposes.

### BACKGROUND

Embodiments of the invention relate to the production of oxygen-consuming electrodes, in particular for use in chloralkali electrolysis, which are electrochemically reduced in an aqueous electrolyte having a pH of <8 in a separate production step and which have good transportability and storability. Further embodiments of the present invention relate to the use of these electrodes in chloralkali electrolysis or fuel cell technology.

The invention proceeds from oxygen-consuming electrodes known per se which are configured as gas diffusion electrodes and usually comprise an electrically conductive support and a gas diffusion layer having a catalytically active component.

Various proposals for producing and operating the oxygen-consuming electrodes in electrolysis cells of an industrial size are known in principle from the prior art. The basic idea is to replace the hydrogen-evolving cathode in the electrolysis (for example in chloralkali electrolysis) by the oxygen-consuming electrode (cathode). Anode and cathode are here separated by an ion-exchange membrane. An overview of possible cell designs and solutions may be found in the publication by Moussallem et al “Chlor-Alkali Electrolysis with Oxygen Depolarized Cathodes: History, Present Status and Future Prospects”, J. Appl. Electrochem. 38 (2008) 1177-1194.

The oxygen-consuming electrode, hereinafter also referred to as OCE for short, has to meet a number of requirements in order to be able to be used in industrial electrolysers. Thus, the catalyst and all other materials used have to be chemically stable to sodium hydroxide solution having a concentration of about 32% by weight and to pure oxygen at a temperature of typically 80-90° C. A high measure of mechanical stability is likewise required since the electrodes are installed and operated in electrolysers having a size of usually more than 2 m² in area (industrial size). Further properties are: a high electrical conductivity, a low layer thickness, a high internal surface area and a high electrochemical activity of the electrocatalyst. Suitable hydrophobic and hydrophilic pores and an appropriate pore structure for the conduction of gas and electrolyte are likewise necessary, as is impermeability so that gas space and liquid space remain separated from one another. Long-term stability and low production costs are further particular requirements which an industrially usable oxygen-consuming electrode has to meet.

An oxygen-consuming electrode typically consists of a support element, for example a plate of porous metal or mesh made of metal wires, and an electrochemically active coating. The electrochemically active coating is microporous and consists of hydrophilic and hydrophobic constituents. The hydrophobic constituents make penetration of electrolytes difficult and thus keep the appropriate pores for transport of oxygen to the catalytically active sites free. The hydrophilic constituents make it possible for the electrolyte to penetrate to the catalytically active sites and for the hydroxide ions to be transported away. As hydrophobic component, use is generally made of a fluorine-containing polymer such as polytetrafluoroethylene (PTFE) which also serves as polymeric binder for the catalyst. In the case of electrodes having a silver catalyst, the silver serves as hydrophilic component.

Many compounds have been described as catalyst for the reduction of oxygen.

There are thus reports of the use of palladium, ruthenium, gold, nickel, oxides and sulphides of transition metals, metal porphyrins and phthalocyanins and pervoskites as catalyst for oxygen-consuming electrodes.

However, only platinum and silver have attained practical importance as catalyst for the reduction of oxygen in alkaline solutions.

Platinum has a very high catalytic activity for the reduction of oxygen. Owing to the high cost of platinum, this is used exclusively in supported form. A preferred support material is carbon.

Carbon conducts electric current to the platinum catalyst. The pores in the carbon particles can be made hydrophilic by oxidation of the surfaces and thus become suitable for the transport of water. OCEs having carbon-supported platinum catalysts display good performance. However, the resistance of carbon-supported platinum electrodes in long-term operation is unsatisfactory, presumably because oxidation of the support material is also catalysed by platinum. Carbon also promotes the undesirable formation of H₂O₂.

Silver likewise has a high catalytic activity for the reduction of oxygen.

Silver can be used in carbon-supported form and also as finely divided metallic silver.

OCEs having carbon-supported silver usually have silver concentrations of 20-50 g/m². Although the carbon-supported silver catalysts are more durable than the corresponding platinum catalysts, the long-term stability under the conditions of chloralkali electrolysis is limited.

Preference is given to using unsupported silver as catalyst. In the case of OCEs having catalysts composed of unsupported metallic silver, there are naturally no stability problems caused by decomposition of the catalyst support.

In the production of OCEs having an unsupported silver catalyst, the silver is preferably introduced at least partly in the form of silver oxides which are then reduced to metallic silver. In the reduction of the silver compounds, a change in the arrangement of the crystallites, in particular also bridge formation between individual silver particles, occurs. This leads overall to a strengthening of the structure.

In the manufacture of oxygen-consuming electrodes having a silver catalyst, a distinction may be made in principle between dry and wet manufacturing processes.

In the dry processes, a mixture of catalyst and a polymeric component (usually PTFE) is milled to fine particles which are subsequently distributed on an electrically conductive support element and pressed at room temperature. Such a process is described, for example, in EP 1728896 A2.

In the wet manufacturing processes, either a paste or a suspension of catalyst and polymeric component in water or another liquid is used. Surface-active substances can be added in the production of the suspension in order to increase the stability of the latter. A paste is subsequently applied to the support by screen printing or calendering, while the less viscous suspension is usually sprayed on. The support together with the applied paste or suspension is dried and sintered. Sintering is carried out at temperatures in the region of the melting point of the polymer. Furthermore, densification of the OCC can also be carried out at a temperature above room temperature (up to the melting point, softening point or decomposition point of the polymer) after sintering.

The electrodes produced by these processes are installed in the electrolyser without prior reduction of the silver oxides. The reduction of the silver oxides to metallic silver occurs under the action of the electrolysis current after filling of the electrolyser with the electrolytes.

### DESCRIPTION OF PREFERRED EMBODIMENTS

It has now been found that the OCEs produced according to the prior art have disadvantages in handling. Thus, the catalyst layer is not very stable mechanically, as a result of which damage such as detachment of parts of the unreduced catalyst layer can easily occur. Particularly when the OCE is installed in the electrolyser, the OCE has to be bent. The damage which occurs here leads to loss of impermeability in operation, so that electrolyte can get through the OCE into the gas space.

Electrodes for industrial plants are frequently produced in central manufacturing facilities and transported from there to the individual use locations. As a result, the transportability and storability have to meet particular requirements. The OCEs have to be insensitive to stresses during transport and installation on site.

The noble metal oxide-containing electrodes are generally not installed and operated in the electrolyser immediately after manufacture. Thus, relatively long periods of time can elapse both between manufacture and installation and also between installation and start-up.

When the OCC is installed in the electrolyser and stands for a prolonged period of time, a deterioration in performance can occur. The ion-exchange membrane which has to be kept moist is present in the electrolyser. The installed OCC is therefore always exposed to high ambient humidity which has an adverse effect on the noble metal oxides. Insipient hydrolysis processes alter the grain surfaces and thus the electrochemically active surface area present after reduction. This change has, for example, an adverse effect on the electrolysis potential.

The activity of the OCE is influenced, inter alia, by the conditions under which the silver oxide is reduced to metallic silver. In an industrial plant for the production of chlorine and sodium hydroxide, it cannot be ensured that the conditions optimal for the reduction are maintained during start-up of an unreduced OCE.

Methods of reducing silver oxides in oxygen-consuming electrodes are described in DE 3710168 A1. Cathodic reduction in potassium hydroxide solution, chemical reduction by means of zinc and electrochemical reduction against a hydrogen electrode are all mentioned. Mention is likewise made of the abovementioned process in which unreduced electrodes are installed in an electrolyser and the reduction is carried out at the beginning of the electrolysis.

The methods mentioned are not very suitable for the production of oxygen-consuming electrodes which have satisfactory mechanical stability and a high storage stability.

In industrial practice, reduction by means of zinc or by means of other metals is associated with considerable problems. Particular mention may be made of contamination of the electrodes with the respective metal or metal oxide and the risk of blockage of the pores.

The reduction against a hydrogen electrode which is likewise mentioned in DE 3710168 A1 and in which the strip-shaped electrode is allowed to discharge against a likewise strip-shaped hydrogen electrode during passage through a discharge cell is difficult to realise outside the laboratory and is ruled out as a method on the industrial scale.

In an electrochemical reduction in aqueous solutions of sodium hydroxide or potassium hydroxide, various problems occur when the electrode is not used promptly after the reduction.

Damage to the electrode can occur, for example, due to formation of alkali metal carbonates from the alkali metal hydroxide and carbon dioxide present in air. The alkali metal carbonate can block the pores of the OCE, as a result of which the latter can become completely unusable or the electrolysis has to be carried out at significantly higher voltages.

Furthermore, the alkali metal hydroxide solution which remains can become more concentrated during storage as a result of evaporation of water. Here, the alkali metal hydroxide can crystallize out and thereby block the pores of the OCE or irreversibly destroy the pores due to the crystals which form. To avoid the problems mentioned, the alkali metal hydroxide solution has to be completely removed from the electrode after the reduction. This can be carried out only with difficulty in the case of a fine-pored electrode. Since the reduced OCE always contains traces of alkali metal hydroxide, installation of the OCE in the electrolyser is made difficult as a result of increased safety measures (avoidance of burning by alkali metal hydroxide).

Reduction in alkaline solution is therefore not very suitable for the production of oxygen-consuming electrodes if these are to be transported and/or stored over a prolonged period of time.

It is an object of the present invention to provide a ready-to-use oxygen-consuming electrode, in particular for use in chloralkali electrolysis, which is transport- and storage-stable and can also be installed before start-up in an electrolyser which is kept moist without the activity and life of the electrode being reduced.

A specific object of the present invention is to find a process by means of which the oxygen-consuming electrodes can be prepared in such a way that, firstly, a high-performance silver catalyst layer which is stable in the long term is produced and, secondly, the reduced electrodes are insensitive to damage during transport and storage and are sufficiently mechanically stable for installation in the electrolyser and are stable to moisture.

The object is achieved, for example, in the manufacture of the OCE by, after application and strengthening of the catalytically active layer on the support (hereinafter referred to as intermediate), the silver oxides present therein being electrochemically reduced in an aqueous electrolyte having a pH of <8 in a separate step.

An embodiment of the present invention is a process for producing a transport- and storage-stable sheet-like oxygen-consuming electrode comprising providing an electrically conductive support, a gas diffusion layer, and a layer comprising a silver-based catalyst, coating the support with a silver oxide-containing intermediate, and at least partly electrochemically reducing the silver oxide-containing intermediate in an aqueous electrolyte at a pH of less than 8.

The silver oxide-containing intermediate comprises, in particular, at least silver oxide and a finely divided, in particular hydrophobic material, preferably PTFE powder.

The reduction can be carried out in a cell comprising an anode, an electrolyte and a device for taking up and supplying charge from/to the OCE to be connected cathodically. Techniques known from electrochemical technology can be used here.

Anode and OCE can dip into a chamber without separation. Since hydrogen can be evolved at the OCE during the course of the electrochemical reduction and this hydrogen would form an explosive mixture with the oxygen formed at the anode, it is advantageous to separate anode and cathode. This can be achieved, for example, by means of a diaphragm or a membrane. The gases in the respective gas space can then be discharged separately. However, the danger posed by hydrogen can also be prevented in other ways known to those skilled in the art, for example by flushing with an inert gas.

The design of the anode is carried out in a manner known to those skilled in the art. Shape and arrangement should preferably be chosen so that the current density is uniformly distributed at the cathode. The anode can be coated on its surface with further materials such as iridium oxide which reduce the overvoltage for oxygen. As electrolyte for carrying out the reduction, it is possible to use aqueous solutions, in particular solutions of the sulphates or nitrates, of the alkali metals and alkaline earth metals or of silver.

The electrolyte therefore preferably comprises ions of an element of the alkali metal or alkaline earth metal group or of silver, particularly preferably of silver.

In the case of electrodes which are later to be used for the electrolysis of sodium chloride, an aqueous solution of sodium sulphate is useful as electrolyte; the use of a sodium salt prevents the sodium hydroxide to be produced later from being contaminated by introduction of further cations. Correspondingly, potassium sulphate is useful in the case of electrodes for the electrolysis of potassium chloride.

However, it is also possible to use other salts of the alkali metals and alkaline earth metals, for example nitrates.

Chlorides are not suitable as electrolytes. There is a risk that silver chloride will be formed in the electrode, and this is considerably more difficult to reduce than silver oxide. Thus, it should be ensured, in particular, that few or no chloride ions are present in the electrolyte. The chloride content of the electrolyte should, in particular, be not more than 1000 ppm, preferably not more than 100 ppm, very particularly preferably 20 ppm, of chloride.

The pH of the electrolyte should preferably be selected so that no insoluble silver hydroxides can be formed. This is the case at a pH of <8. The reduction is particularly preferably carried out in a pH range from 3 to 8, preferably at a pH of from 4 to 7.

Preferred electrolytes are solutions of water-soluble silver salts such as silver nitrate, silver acetate, silver fluoride, silver propionate, silver lactate and silver sulphate, with particular preference being given to silver sulphate and silver nitrate. Complex silver cyanides such as sodium cyanoargentate or potassium cyanoargentate, silver molybdate and also salts of pyrophosphoric acid, perchloric acid and chloric acid can likewise be used as electrolytes.

Silver salts remaining in the electrode after the reduction have no adverse effect. Further substances can be added to the electrolyte in order to improve the reduction procedure. Thus, it is advisable, for example when silver sulphate is used, to acidify the solution with sulphuric acid or nitric acid in order to avoid precipitation of silver oxide. However, buffer substances such as sodium acetate can also be added to regulate the pH.

There are many further available additives which are known in principle from, for example, electrochemical technology. A person skilled in the art will in each case decide whether and which further known additives can be used as an aid to improve the electrochemical reduction and also to improve the storage stability of the electrode and to avoid later product contamination.

Combinations of a plurality of salts can also be used as electrolytes. Thus, for example, a mixture of silver sulphate and sodium sulphate in water or mixtures of sodium nitrate and sodium sulphate can be used.

The concentration of the electrolytes varies in the range known to a person skilled in the art from electrochemical technology. The concentration can be selected within a wide range, in particular at least 0.01 mol/l, preferably from 0.01 mol/l to 2 mol/l, with the concentration also being able to be determined by the solubility of the electrolyte. Preference is given to choosing a very high concentration of the electrolyte in order to minimize the potential drop across the electrolyte and thus the electrolysis potential.

When anode and cathode spaces are separated by a membrane, it is possible to use different electrolytes on the anode side and the cathode side. The requirements which the electrolyte has to meet on the cathode side remain the same as when there is no separation of anode space and cathode space. However, on the anode side it is possible to use electrolytes which are independent of the requirements which the electrolyte has to meet on the cathode side. Thus, an alkali metal hydroxide solution can be used as electrolyte on the anode side, and the increase in the concentration of hydroxide ions gives a reduction in the potential drop across the electrolyte on the anode side.

To condition the electrolyte, it is possible to use the techniques known from electrochemical technology, for example pump circulation, cooling, filtration.

The OCE to be reduced is preferably introduced into the apparatus in such a way that uniform flow occurs over the entire electrode surface and uniform reduction can take place over the entire surface. Appropriate techniques are known to those skilled in the art. In the case of different coatings on the front and rear sides of the electrically conductive support element, the arrangement is preferably such that the side having the higher content of silver oxide faces the anode.

It is advisable, in particular, to condition the OCE by laying in water or preferably in an electrolyte before introduction into the reduction apparatus. Conditioning can be carried out over a number of hours, preferably 0.1-8 hours, and has the aim of filling the hydrophilic pores ideally completely.

There are various possible ways of supplying power to the OCC to be reduced. Thus, the power can be supplied by the support element, for example by the support element not being coated at the edge and the power being supplied via a clip or other connection via the support element.

However, the power can also be supplied via a component lying flat on the OCE, for example an expanded metal or woven or knitted metal mesh. In such an arrangement, the power is transmitted via a plurality of contact points.

The reduction can in principle be carried out at a relatively low current density of about 0.1 kA/m² or even lower. The reduction is, however, preferably carried out at a very high current density. Current densities of >1 kA/m² are therefore preferred. Since the outlay in terms of apparatus increases with increasing current density, the practical upper limit would be 5 kA/m², but reduction can also be carried out, if technical circumstances allow, at higher current densities of up to 10 kA/m² and above. A preferred process is therefore characterized in that the reduction is carried out at a current density of from 0.1 to 10 kA/m².

The duration of the reduction depends on the desired degree of reduction, the current density, the loading of the electrode with silver oxide and the losses caused by secondary reactions.

In general, it is sufficient, in a preferred embodiment of the process, for about 50% of the silver oxide to be reduced to metallic silver in order to obtain an OCE which is sufficiently strong for transport. To rule out problems due, for example, to a change in the remaining silver oxide as a result of moisture, particular preference is given to a reduction of more than 90%, very particularly preferably complete reduction.

It is known that 1000 coulomb (corresponding to 1000 ampere×second) are required for the reduction of 1.118 g of monovalent silver ions; in the case of divalent silver, double the charge is accordingly required. At a loading of 1150 g of silver(I) oxide per m², 266 Ah are theoretically required for complete reduction. Owing to secondary reactions, the actual quantity of charge required will be higher.

The duration of the reduction can be controlled via the electrolysis potential.

The reduction is carried out in a temperature range from 10° C. to 95° C., preferably in the range from 15° C. to 50° C., particularly preferably in the range from 20° C. to 35° C.

The electrolyte warms up during the reduction. The heat evolved can be removed by appropriate cooling, but the reduction can also be carried out adiabatically with increasing bath temperatures.

In a preferred embodiment of the novel process, the gas diffusion layer and the catalyst-containing layer are formed by a single layer. This is achieved, for example, by the single layer containing the gas diffusion layer and the catalyst being formed by use of a mixture of silver oxide-containing powder and hydrophobic powder, in particular PTFE powder, and reduced.

In a preferred variant of the novel process, the gas diffusion layer and the catalyst-containing layer are formed by at least two different layers. This is achieved, for example, by the gas diffusion layer and the catalyst-containing layer being formed by use of at least two different mixtures of silver oxide-containing powder and hydrophobic powder, in particular PTFE powder, having differing contents of silver oxide in two or more layers and then reduced.

The manufacture of an OCE by the process of embodiments of the present invention is described in more detail below without the scope of the invention being restricted to the specific embodiments described below.

The preparation of the silver oxide-containing intermediate is carried out, for example, by the wet or dry production techniques known per se. These are, in particular, carried out as described above.

For example, the aqueous suspension or paste comprising silver oxide, optionally also finely divided silver, a fluorine-containing polymer such as PTFE and optionally a thickener (for example methylcellulose) and an emulsifier which is used in the wet production process is produced by mixing the components by means of a high-speed mixer. For this purpose, a suspension of silver oxide, optionally finely divided silver, the thickener (for example methylcellulose) and the emulsifier in water and/or alcohol is firstly produced. This suspension is then mixed with a suspension of a fluorine-containing polymer as is commercially available, for example, under the trade name Dyneon™ TF5035R. The emulsion or paste obtained in this way is then applied by known methods to a support, dried and sintered. To make supply of power by means of direct contact with the support element possible after the subsequent reduction, the edge of the support element can be kept free of the coating.

As an alternative, in the preferred dry production process, a powder mixture is produced by mixing a mixture of PTFE or another fluorine-containing polymer, silver oxide and optionally silver particles in a high-speed mixer. In the milling operations, it should in each case be ensured that the temperature of the mixture is kept in the range from 35 to 80° C., particularly preferably from 40 to 55° C.

The powder mixture is then applied to a support and densified in a known manner. To make supply of power via direct contact with the support element possible after the subsequent reduction, the edge of the support element can be kept free of the coating.

The silver oxide-containing intermediate produced by the wet or dry process is, after coating and densification or sintering, conditioned in a bath by means of water or an electrolyte for up to a number of hours.

The conditioned electrode is then transferred to an apparatus for electrochemical reduction.

A silver sulphate solution is preferably used as electrolyte. As an alternative, other electrolyte additives as described above, e.g. silver nitrate, silver acetate or silver propionate, can be used. Sulphates and other salts of the alkali and alkaline earth metals, with the exception of the chlorides and salts of other anions which form sparingly soluble salts or explosive, readily decomposable compounds with silver, are likewise suitable. The pH can be set to a range <8, preferably from 3 to 8, by means of sulphuric acid or a buffer solution. The chloride content of the electrolyte should preferably be not more than 1000 ppm, particularly preferably not more than 100 ppm, very particularly preferably not more than 20 ppm, of chloride.

An oxygen-evolving electrode is preferably selected as anode in the reduction. This can be, for example, a platinum-coated nickel sheet or an iridium oxide-coated titanium sheet. However, it is also possible to use anodes made of other materials which do not dissolve or silver as soluble anode.

The area of the anode should as far as possible be the same as the area of the OCE to be reduced.

Power can be supplied via a clip or another connection at the uncoated edge of the support element of the OCE. However, the power can also be supplied via a component lying flat on the OCE, for example an expanded metal or a woven or knitted metal mesh. This is necessary, for example, when the support element has been coated over its entire area including the edge region.

A current density of >1 kA/m² is preferably selected for the reduction. The electrolysis potential is determined by the arrangement of the electrodes/diaphragms or ion exchangers in the electrolysis cell and the type of electrolyte. Subsequently, the OCE is taken from the electrolysis cell. Adhering electrolyte is allowed to run off; the running-off of the catholyte can be aided by further techniques which are known per se to those skilled in the art, for example blowing with air. The OCE is then rinsed with deionized water, for example by spraying or dipping into a bath containing deionized water. The OCE is subsequently packed in a water-tight manner.

The consistency of the OCE has solidified significantly as a result of the reduction. The OCE is insensitive to mechanical damage and can be transported and, for example, installed in a chloralkali electrolysis cell without problems. The OCE retains its activity even after prolonged storage in a moist atmosphere.

The oxygen-consuming electrode produced by the process of embodiments of the present invention is preferably connected as cathode, in particular in an electrolysis cell for the electrolysis of alkali metal chlorides, preferably sodium chloride or potassium chloride, particularly preferably sodium chloride.

As an alternative, the oxygen-consuming electrode produced by the process of the embodiments of the invention can preferably be connected as cathode in a fuel cell. Preferred examples of such fuel cells are alkaline fuel cells.

Other embodiments of the invention therefore further provides for the use of the oxygen-consuming electrode produced by the process of the invention for the reduction of oxygen in an alkaline medium, in particular as oxygen-consuming cathode in electrolysis, in particular in chloralkali electrolysis, or as electrode in a fuel cell or as electrode in a metal/air battery.

The novel OCE produced by the process of the embodiments of the invention is particularly preferably used in chloralkali electrolysis and here in particular in the electrolysis of sodium chloride (NaCl).

Embodiments of the present invention is illustrated below by the examples which do not, however, constitute any restriction of the invention.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLE

3.5 kg of a powder mixture consisting of 7% by weight of PTFE powder, 88% by weight of silver(I) oxide and 5% by weight of silver powder of the grade 331 from Ferro were mixed at a rotational speed of 6000 rpm in an Eirich model R02 mixer equipped with a star spinner as mixing element in such a way that the temperature of the powder mixture does not exceed 55° C. This was achieved by the mixing operation being interrupted and the mixture being cooled. Mixing was carried out a total of six times. After mixing, the powder mixture was sieved by means of a sieve having a mesh opening of 1.0 mm.

The sieved powder mixture was subsequently applied to a nickel mesh having a wire thickness of 0.14 mm and a mesh opening of 0.5 mm. Application was carried out with the aid of a 2 mm thick template, with the powder being applied by means of a sieve having a mesh opening of 1 mm. Excess powder which projected above the thickness of the template was removed by means of a scraper. After removal of the template, the support together with the applied powder mixture was pressed by means of a roller press at a pressing force of 0.5 kN/cm. The OCE was taken from the roller press.

The OCE was subsequently installed in a cathode chamber containing a silver sulphate solution acidified with sulphuric acid (8 g of Ag₂SO₄ per litre, pH 3) as electrolyte. Electrical contacting of the OCE was effected via an expanded metal having a mesh opening of 6 mm laid flat on top. The cathode chamber was separated from the anode chamber by a DuPont Nafion N 234 ion-exchange membrane. The anode chamber was filled with 32% strength by weight NaOH, and a 1.5 mm thick, platinum-coated nickel sheet served as anode.

The OCE was conditioned in the electrolyte at room temperature for 2 hours before installation.

The OCE was reduced at a current density of 1 kA/m² for 40 minutes.

The OCE was taken from the bath. After adhering electrolyte had run off, the electrode was dipped into a bath containing deionized water and, after the adhering water had dripped off, a stable electrode suitable for despatch was obtained.

The OCE was used in the electrolysis of a sodium chloride solution in an electrolyser having a DuPONT N982WX ion-exchange membrane and a sodium hydroxide gap between OCE and membrane of 3 mm. The electrolysis potential was 2.02 V at a current density of 4 kA/m², an electrolyte temperature of 90° C. and a sodium hydroxide concentration of 32% by weight. A commercial noble metal-coated titanium electrode having a coating from DENORA was used as anode at an NaCl concentration of 200 g/l.

1. A process for producing a transport- and storage-stable sheet-like oxygen-consuming electrode comprising
providing an electrically conductive support, a gas diffusion layer, and a layer comprising a silver-based catalyst,
coating the support with a silver oxide-containing intermediate, and
at least partly electrochemically reducing the silver oxide-containing intermediate in an aqueous electrolyte at a pH of less than 8.

2. The process according to claim 1, wherein the electrolyte comprises ions of an element from the alkali metal or alkaline earth metal group or of silver.

3. The process according to claim 2, wherein the electrolyte comprises silver ions.

4. The process according to claim 1, wherein the electrolyte comprises sulphate and/or nitrate ions.

5. The process according to claim 1, wherein the electrolyte comprises not more than 1000 ppm of chloride.

6. The process according to claim 1, wherein the electrolyte comprises not more than 20 ppm of chloride.

7. The process according to claim 1, wherein the reduction is carried out at a current density of from 0.1 to 10 kA/m².

8. The process according to claim 1, wherein the reduction of the silver oxide occurs to an extent of more than 50%.

9. The process according to claim 1, wherein the reduction of the silver oxide occurs completely.

10. The process according to claim 1, wherein the electrolyte has a concentration of metal cations of at least 0.01 mol/l.

11. The process according to claim 1, wherein the electrolyte has a concentration of metal cations of from 0.01 mol/l to 2 mol/l.

12. The process according to claim 1, wherein the electrochemical reduction is carried out at a pH of from 3 to 8.

13. The process according to claim 1, wherein the electrochemical reduction is carried out at a pH of from 4 to 7.

14. The process according to claim 1, wherein the electrochemical reduction is carried out at a temperature of from 10 to 95° C.

15. The process according to claim 1, wherein the electrochemical reduction is carried out at a temperature of from 15° C. to 50° C.

16. The process according to claim 1, wherein the gas diffusion layer and the catalyst-containing layer are formed by a single layer.

17. The process according to claim 1, wherein the gas diffusion layer and the catalyst-containing layer are formed by at least two different layers.

18. An oxygen-consuming cathode for electrolysis, in particular chloralkali electrolysis comprising the oxygen-consuming electrode made by the process according to claim 1.

19. An electrode in a fuel cell or an electrode in a metal/air battery comprising the oxygen consuming electrode made by the process according to claim 1.

20. An electrolysis apparatus, in particular for chloralkali electrolysis, comprising an oxygen-consuming electrode made by the process according to claim 1 as an oxygen-consuming cathode.
